(19) United States
(12) Patent Application Publication
(10) Pub. No.: US 2010/0254695 A1
(43) Pub. Date: Oct. 7, 2010

(54) IMAGE CAPTURING APPARATUS

(75) Inventors: MING-TESUNG CHENG, Tu-Cheng (TW); CHIUNG-LI CHANG, Tu-Cheng (TW); LI-ZHANG HUANG, Tu-Cheng (TW); TE-YUAN KUNG, Tu-Cheng (TW); HAN-CHE WANG, Tu-Cheng (TW); CHENG-HAO CHOU, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/631,847

(22) Filed: Dec. 6, 2009

(30) Foreign Application Priority Data
Apr. 3, 2009 (CN) 200910301352.X

(51) Int. Cl. G03B 17/00

(52) U.S. Cl. 396/419

(57) ABSTRACT

An image capturing apparatus includes a support assembly, a holding member, and an image capturing member. The support assembly includes a base member and a support member. The support member is configured for receiving a paper printed photo. The holding member is rotatably connected to the support member. The image capturing member is mounted on a bottom surface of the holding member. When the holding member is kept in an open position, the image capturing member is activated to capture an image of the paper printed photo received in the base member.

### BACKGROUND

1. Technical Field

The present disclosure relates to image capturing apparatuses and, particularly, to an image capturing apparatus capable of capturing image of paper printed photos.

2. Description of Related Art

Although digital cameras have all but replaced conventional cameras, a plurality of photos printed on photo sensitive papers are still reserved by consumers. Typically, in order to display the images of these photos using digital photo frames, consumers have to use a scanner, which is convenient and expensive.

### BRIEF DESCRIPTION OF THE DRAWINGS

The components of the drawings are not necessarily drawn to scale, the emphasis instead being placed upon clearly illustrating the principles of an image capturing apparatus. Moreover, in the drawings, like reference numerals designate corresponding parts throughout several views.

FIG. 1 is a side view of the image capturing apparatus in accordance with a first embodiment.

FIG. 2 is an isometric view of the image capturing apparatus of FIG. 1.

FIG. 3 is an isometric view of the image capturing apparatus in accordance with a second embodiment.

FIG. 4 is a perspective view of the image capturing apparatus of FIG. 1, showing the image capturing apparatus connected to an external electronic apparatus.

FIG. 5 is an isometric view of the image capturing apparatus in accordance with a third embodiment.

### DETAILED DESCRIPTION

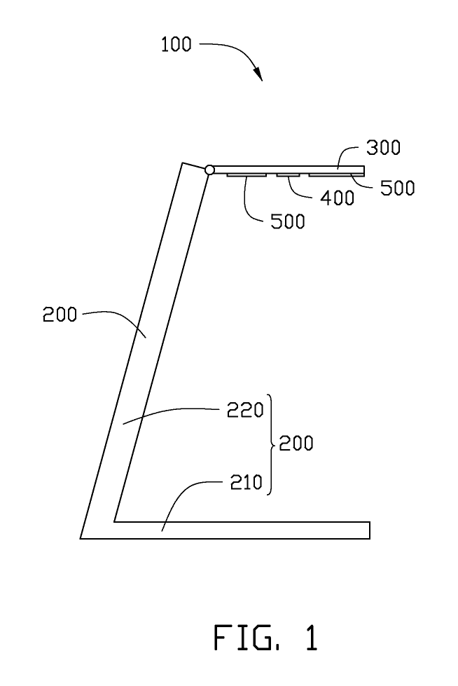

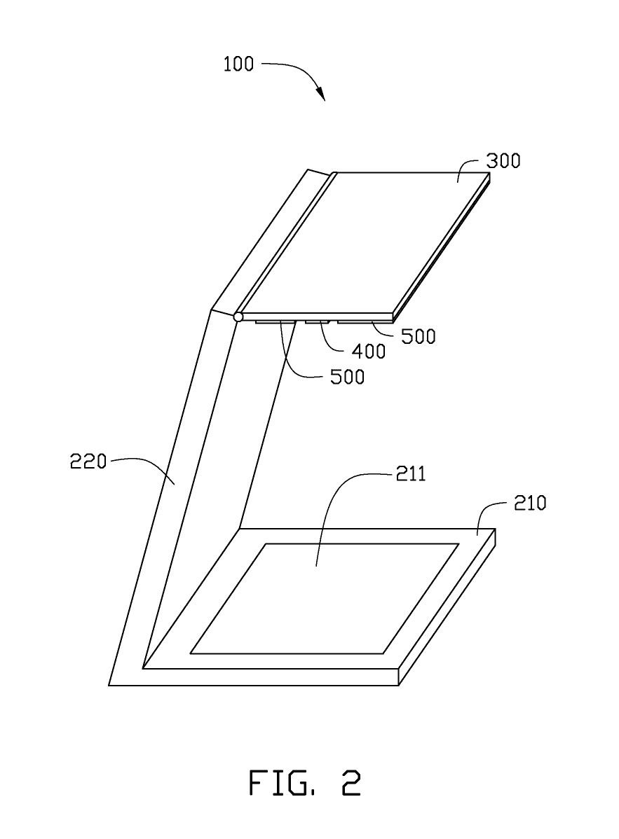

Referring to FIGS. 1-2, an embodiment of an image capturing apparatus 100 is illustrated. The apparatus 100 includes a support assembly 200, a holding member 300, an image capturing member 400, and at least one light member 500.

The support assembly 200 includes a base member 210 and a support member 220. In the embodiment, the support member 220 is secured to the base member 210. In an alternative embodiment, the support member 220 can be rotatably connected to the base member 210. A recessed portion 211 is formed on the top surface of the base member 210 for receiving a paper printed photo. In the embodiment, the recessed portion 211 is substantially square. A transparent panel (not shown) can also be employed to cause the paper printed photo received in the recessed portion 211 to be in a flat state.

The holding member 300 is rotatably connected to the supporting member 220. The holding member 300 can be rotated from a closed position to an open position. When in the closed position, the holding member 300 and the support member 220 are in surface to surface contact. When in the open position, the bottom surface of the holding member 300 is substantially parallel with the bottom surface of the recessed portion 211.

The image capturing member 400 is mounted on the bottom surface of the holding member 300 for capturing an image of the paper printed photo received in the recessed portion 211. When the holding member 300 is in the open position, the image capturing member 400 can be activated to capture the image of the paper printed photo received in the recessed portion 211. In the embodiment, the image capturing member 400 is a camera.

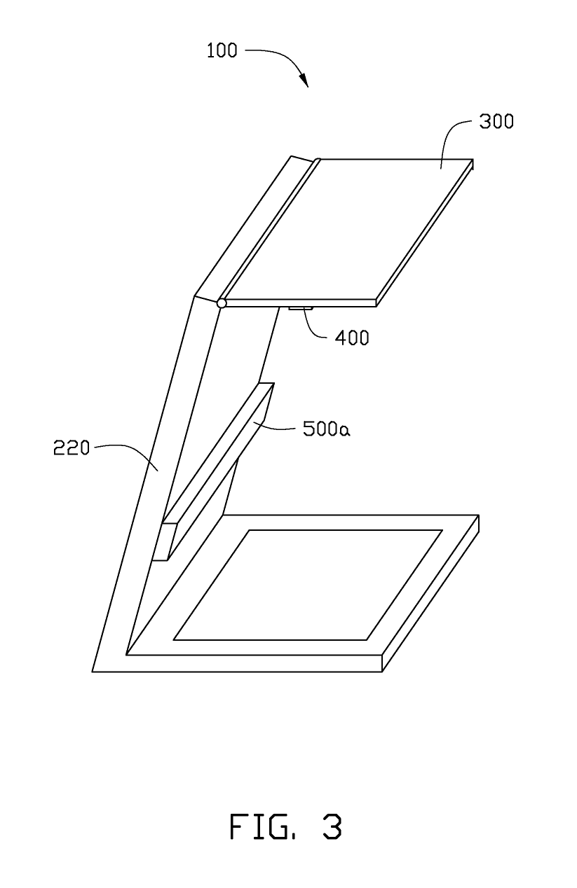

The at least one light member 500 is configured to provide enough lightning during the operation of the image capturing member 400 to ensure the quality of the captured image of the paper printed photo. In the embodiment, a pair of light members 500 is mounted on the bottom surface of the holding member 300. The image capturing member 400 is disposed between the light members 500. In an alternative embodiment, a light element 600a is mounted on the support member 220 (see FIG. 3)

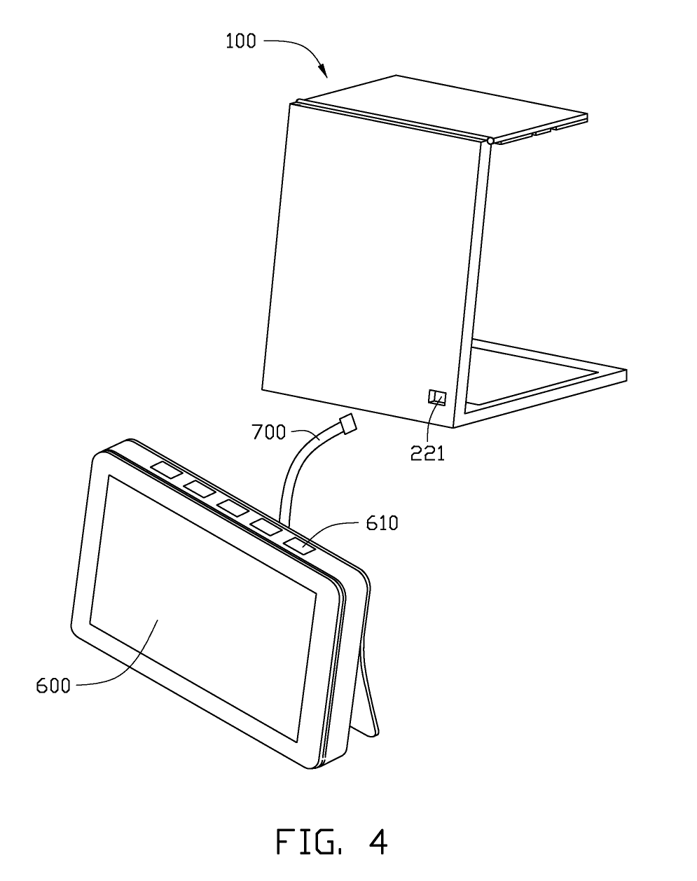

Referring also to FIG. 4, the apparatus 100 can be connected to an external electronic apparatus 600 and is controlled by the external electronic apparatus 600. In this embodiment, the apparatus 100 further includes an interface unit 221. The interface unit 221 is electrically connected to a data line 700 which is electrically connected the external electronic apparatus 600. The external electronic apparatus 600 includes a button 610 which is employed to generate a control signal in response to user input. The control signal is transmitted to the apparatus 100 via the data line 700. Upon receiving the control signal, the image capturing member 400 is activated to capture the image of the paper printed photo received in the recessed portion 211, and the light members 500 are also activated to provide lightning to ensure the quality of the captured image of the paper printed photo. The captured image of the paper printed photo can be transmitted to the external electronic apparatus 600 or other external storage apparatus (not shown). In this embodiment, the external electronic apparatus 600 is a digital photo frame.

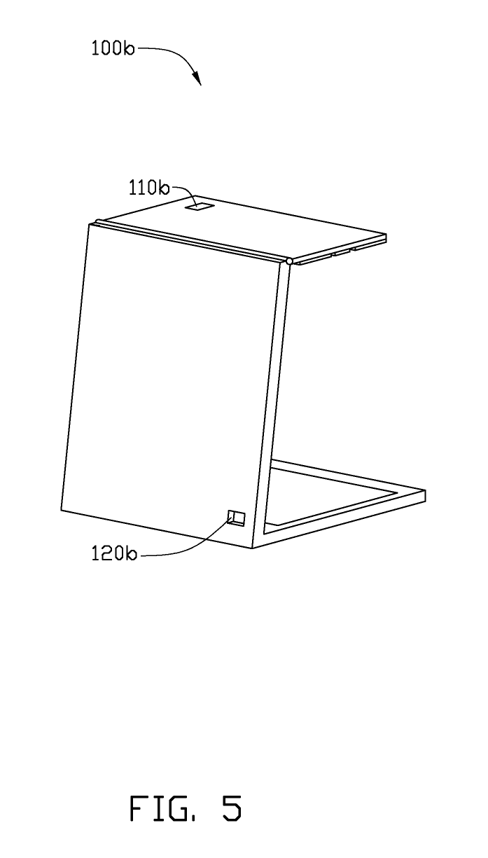

Referring also to FIG. 5, another embodiment of an apparatus 100b is illustrated. The apparatus 100b includes a button 110b, an interface unit 120b, a control unit (not shown), and a power unit (not shown). The apparatus 100b is connected to an external storage apparatus (not shown) via the interface unit 120b. The power unit is configured to provide power to the apparatus 100b. The button 110b is employed to generate a control signal in response to user input. Upon receiving the control signal, the control unit activates the image capturing member 400 and the light member 500, and also transmits the captured image of the paper printed photo received in the recessed portion 211 to the external storage apparatus.

Although the present disclosure has been specifically described on the basis of the exemplary embodiment thereof, the disclosure is not to be construed as being limited thereto. Various changes or modifications may be made to the embodiment without departing from the scope and spirit of the disclosure.

What is claimed is:

1. An image capturing apparatus comprising:
a support assembly comprising a base member and a support member, wherein the support member is configured for receiving a paper printed photo;
a holding member rotatably connected to the support member; and
an image capturing member mounted on a bottom surface of the holding member;
wherein when the holding member is kept in an open position, the image capturing member is activated to capture an image of the paper printed photo received in the base member.

2. The apparatus as described in claim 1, wherein the support member is secured to the base member.

3. The apparatus as described in claim 1, wherein the support member is rotatably connected to the base member.

4. The apparatus as described in claim 1, wherein at least one light member is mounted on the bottom surface of the holding member for providing enough lightning during the operation of the image capturing member.

5. The apparatus as described in claim 4, wherein the at least one light member is a pair of light members mounted on the bottom surface of the holding member, and the image capturing member is disposed between the light members.

6. The apparatus as described in claim 1, wherein at least one light member is mounted on the support member configured for providing enough lightning during the operation of the image capturing member.

7. The apparatus as described in claim 1, wherein a recessed portion is formed on a top surface of the base member for receiving the paper photo.

8. The apparatus as described in claim 7, wherein the recessed portion is square.

9. The apparatus as described in claim 7, wherein when the holding member is in the open position, the bottom surface of the holding member is parallel with a bottom surface of the recessed portion.

10. The apparatus as described in claim 1 further comprising an interface unit, wherein the image capturing apparatus is connected to an external electronic apparatus via the interface unit and is controlled by the external electronic apparatus.

11. The apparatus as described in claim 1 further comprising an interface unit and a button, wherein the image capturing apparatus is electrically connected to an external storage apparatus via the interface unit, and the button is configured for generating a signal to control the image capturing apparatus in response to user input.
